(19) United States
(12) Patent Application Publication
(10) Pub. No.: US 2007/0192237 A1
(43) Pub. Date: Aug. 16, 2007

(54) Multi-pool loan security mechanism

(75) Inventors: Timothy R. Duoos, Rancho Sante Fe, CA (US); Edward S. Adams, Minneapolis, MN (US)

Correspondence Address: SCHWEGMAN, LUNDBERG, WOESSNER & KLUTH, P.A., P.O. BOX 2938, MINNEAPOLIS, MN, 55402, US

(73) Assignee: American Student Financial Group, Inc.

(21) Appl. No.: 11/355,810

(22) Filed: Feb. 16, 2006

(51) Int. Cl. G06Q 40/00

(52) U.S. Cl. 705/38

(57) ABSTRACT

A multi-pool method of providing loans is performed by receiving a batch of loan applications from a lending entity. Selected loan applications are identified for a first pool and a second pool. The first pool consists of loan applications from borrowers with a better credit rating than the credit rating of borrowers corresponding to the loan applications in the second pool. Loans from the first pool may be purchased. A third pool of funds is formed in exchange for purchasing (by a third party) other selected loans. This third pool may be formed for the benefit of the lending entity, such as a school. Funds from the third pool may be used to offset defaulted loans in the first pool.

### BACKGROUND

Risky loans may be made by entities, who then have a desire to sell the loans, or otherwise obtain cash for the loans. The loans may be made by a lender to allow a lendee to pay for services or goods in one example.

Student loans are available through many different programs. In one program, an entity, such as the US Government may guarantee a loan for a student. The guarantee may be given even if the student has a poor credit rating, and may not qualify for financing from private for profit institutions. One problem with such loans is that they may not cover the cost of tuition for many schools. Some schools may help fill the gap, by loaning the remaining tuition to the student, providing what is referred to as a gap loan. Such loans may be risky, and typically are at a fairly high interest rate, require interest only payments while the student is in school, and then have a 5-6 year amortization. The terms of such loans may vary significantly. Schools may sell such gap loans to private entities to obtain cash.

A private entity may pay cash for the loans outright, or in one prior method, separate loan applications in a bundle of loan applications from a school into two separate pools, referred to as pool A and pool B. Pool A consists of loans to students that have a higher credit rating than in pool B. The private entity may run credit reports, and separate the loans into the pools based on desired credit rating thresholds. For example purposes only, pool A may consist of loans to students having credit rating of above 500, while pool B may consist of loans to students having credit ratings of below 500. In a bundle of loan applications worth $200,000, each pool may consist of approximately $100,000.

The private entity in one embodiment may process paperwork and service loans in addition to purchasing the loans in pool A. It may fill out a promissory note for loan applications in pool A in the schools name, which the students sign, and then forward money to the school. It thus owns pool A, and may also service loans from pools A and B, receiving a service fee for loans in pool B. In the event of a default of a loan in pool A, it may replace such a defaulted loan with a loan from pool B, thus decreasing the risk associated with the purchased pool.

The school, however, still has funds tied up on pool B. There is a desire on the part of the school to receive funds from such loans and remove them from their books.

### SUMMARY

A multi-pool method of providing loans is performed by receiving a batch of loan applications from a lending entity. Selected loan applications are identified for a first pool and a second pool. The first pool consists of loan applications from borrowers with a better credit rating than the credit rating of borrowers corresponding to the loan applications in the second pool. Loans from the first pool may be purchased. A third pool of funds is formed in exchange for purchasing (by a third party) other selected loans. This third pool may be formed for the benefit of the lending entity, such as a school. Funds from the third pool may be used to offset defaulted loans in the first pool.

### BRIEF DESCRIPTION OF THE DRAWINGS

FIG. 1 is a flow chart illustrating a method of providing financing according to an example embodiment.

FIG. 2 is a flow chart illustrating an alternative method of providing financing according to an example embodiment.

FIG. 3 is a block diagram of a mechanism for providing financing according to an example embodiment.

FIG. 4 is a block diagram of a typical computer system for performing selected portions of methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software may consist of computer executable instructions stored on computer readable media such as memory or other type of storage devices. The term “computer readable media” is also used to represent any means by which the computer readable instructions may be received by the computer, such as by different forms of electromagnetic transmissions. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

In one embodiment, a lending entity is a school, and borrowers are students. However, the lending entity and borrowers are not limited to schools and students, but may be any other groups that lend and borrow money.

The US Government may guarantee a loan for a student enrolled in a school. A school may help fill the gap, by loaning tuition not completely covered by the government guaranteed loan to the student, providing what is referred to as a gap loan. Such loans typically are at a fairly high interest rate, may require interest only payments while the student is in school, and then have a 5-6 year amortization. Schools may sell such gap loans to private entities to obtain cash. The terms and conditions of such loans may vary significantly, and are not limited to loans with interest only payments while in school. Further terms, such as the amortization schedule may also vary significantly.

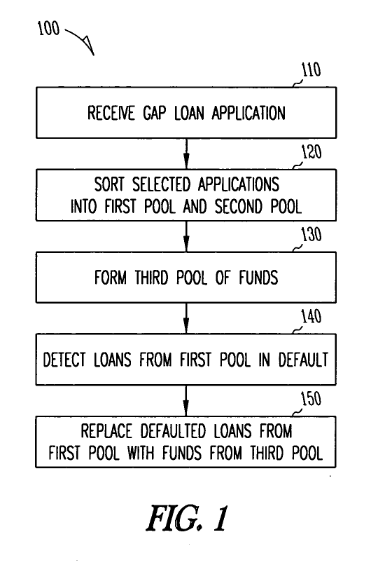

FIG. 1 is a flowchart illustrating a method 100 of providing financing for students attending a school. In one embodiment, selected gap student loan applications are received at 110 and are separated into a first pool and a second pool at 120. The first pool corresponds to loans to students with a better credit rating than the credit rating of students corresponding to the gap student loans in the second pool. In one embodiment, a credit rating is obtained in a standard manner, such as via network or telephone from a credit reporting agency such as FICO. A rating above 500 in one embodiment results in a loan being placed in the first pool, with ratings below 500 placed in the second pool. In further embodiments, loans with very low ratings may be rejected completely, and not included in either pool.

In one embodiment, the selected loan applications are then processed, such as by creating loan documents between the school and each student. The first pool may be purchased by a first entity. In one embodiment, a third party may purchase the government guaranteed loans, as well as the second pool loans if desired, and create a third pool at 130 consisting of funds, such as cash, or loans from the government guaranteed loans, or second pool loans. If a loan from the first pool is detected to be in default at 140, funds from the third pool may be used at 150 to replace the loan in default for the first entity. This provides a relatively low risk for the purchaser of the first pool of loans, allowing the purchaser to provide close to full value to the school for such loans. The school benefits by receiving funds for a substantial portion of the gap loans, and also by having additional students in classrooms that may not have been able to afford school.

In further embodiments, the third pool funds may consist of cash, which may be used to replace defaulted loans from the first pool. If the cash runs out, loans from the second pool, or actually government guaranteed loans may be substituted for the defaulted loans. In further embodiments, the third pool funds consist of loans from the second pool and/or government guaranteed loans that may be used to replace defaulted loans in the first pool.

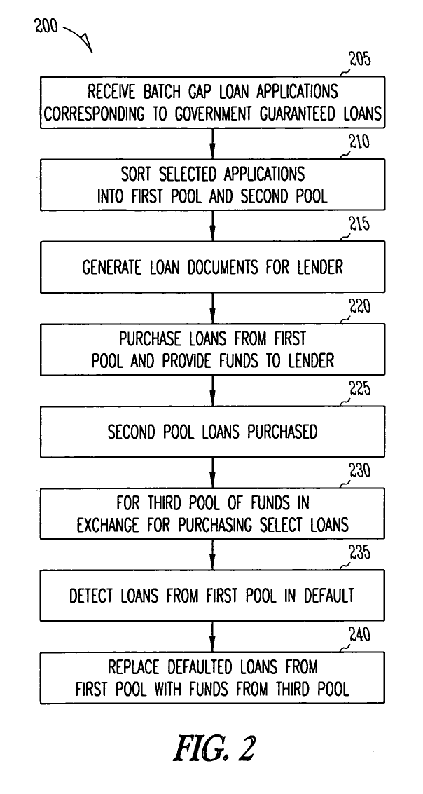

A more detailed loan methodology is shown in FIG. 2 at 200. At 205, a batch of gap loan applications is received. The gap loan applications correspond to government guaranteed loans. At 210, the batch of gap loans is sorted, and selected applications are placed into first and second pools as described above. The first entity may then prepare loan documents for the lender for approved loans. The lender in one embodiment is the school, or an affiliate of the school. The loan documents are basically a promissory note between the school and the student obtaining the loan. The note may specify the principal and repayment terms. Such terms may include repayment terms such that interest only is due while attending school, and then may also specify an interest rate and a term over which the loan may be repaid, referred to as an amortization period. As previously noted, the terms may be varied significantly for different loans.

At 220, the first pool of loans may be purchased by the first entity, with the purchase funds being provided to the school. As part of the purchase, the school may agree to replace loans that are in default with other loans, to minimize the risk associated with the purchase of the first pool of loans.

In a further embodiment, at 230, a third party may purchase selected loans, such as the government guaranteed loans and/or the second pool of loans. In exchange for such purchase, the third party provides funds to a third pool. The third pool may consist of cash or government guaranteed loans or guarantees from the third party to make good on any loans in the first pool that default.

At 235, loans from the first pool may be detected as being in default. The original purchase agreement for such first pool of loans may specify the terms for the default, such as failure to make payments for a specified period of time, failure to locate the student, bankruptcy of the student, or other terms as may be agreed upon. When a loan is detected as being in default, it may be replaced at 240 with funds from the third pool. Such funds may consist of cash, or other loans that are identified as part of the third pool.

In one embodiment, approximately 1 to 4 percent of corresponding government guaranteed student loans being purchased by the third party are being put in the third pool. The amount may vary dependent upon negotiations between the seller and buyer of the government guaranteed loans. The gap loans may be referred to as unsecured sub-prime loans. For many trade schools, such gap loans are currently approximately $4,000. This amount may easily change based on the amounts of government loans available, and the amount of tuition, both of which may change at any point in time.

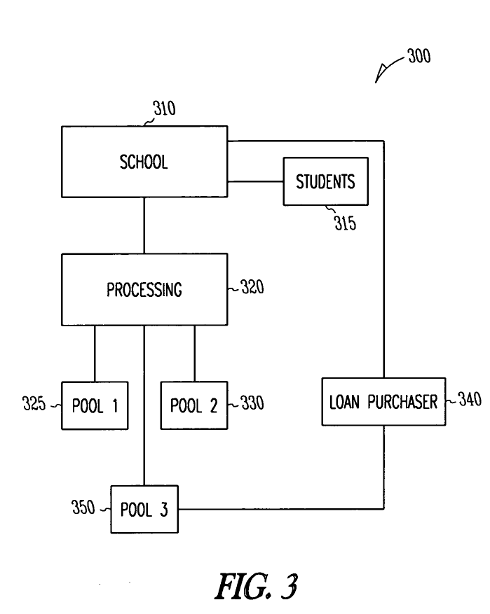

FIG. 3 illustrates a block diagram of various elements of a loan processing mechanism at 300. A school, such as trade school, is indicated at 310, and provides gap loans to cover gaps between generally available financing for students 315, such as guaranteed student loans, and the tuition the school generally charges. The students apply for a gap loan from the school, which batches them together, and provides them to a first entity, referred to as processing 320. The first entity may perform credit checks as above, and group approved loans into a first pool 325 and a second pool 330. Further pools of such loans may also be created as desired and different groups processed as a group one or two pool as described above.

The first entity may purchase loans from the first pool 325 and generally may provide servicing of loans from both pools one and two. Such servicing may include generation of the loan documents, collection of payments and application of payments to the corresponding loans. In one embodiment, principal payments on the second pool of loans may be returned to the school, while interest and finance charges may be kept by the first entity for their servicing services.

In one embodiment, a loan purchaser/third party 340 may purchase the government guaranteed loans, and optionally loans from the second pool, either selected, or all of the loans. In exchange for being able to purchase such loans from the school, the third party 340 pays the school, and also agrees to take on obligations that school may have based on the first entity 320 purchasing the first pool of loans. The obligations are satisfied in one embodiment by creating a third pool of funds 350 that are available to the first entity to cover the risk of defaults on the first pool of loans.

Many of the above functions and services may be provided by a computer system. For instance, the pools may be tracked in spreadsheets running on a programmed computer. Email and word processing functions may be used to create loan documents and receive payments and communicate generally with students, the school and the loan purchaser/third party 340. Similarly, a web based interface may be provided for applying for loans, as well as providing students access to account information on existing loans.

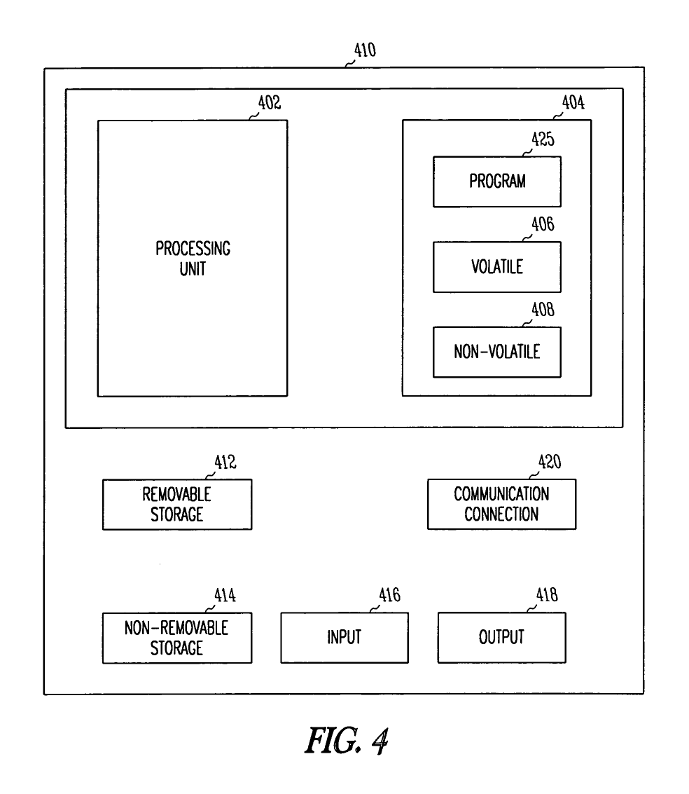

A block diagram of a computer system that executes programming for performing selected portions of the above methods is shown in FIG. 4. A general computing device in the form of a computer 410, may include a processing unit 402, memory 404, removable storage 412, and non-removable storage 414. Memory 404 may include volatile memory 406 and non-volatile memory 408. Computer 410 may include—or have access to a computing environment that includes—a variety of computer-readable media, such as volatile memory 406 and non-volatile memory 408, removable storage 412 and non-removable storage 414. Computer storage includes random access memory (RAM), read only memory (ROM), eraseable programmable read-only memory (EPROM) & electrically eraseable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 410 may include or have access to a computing environment that includes input 416, output 418, and a communication connection 420. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 410. A hard drive, CD-ROM, and RAM are some examples of articles including a computer-readable medium. For example, a computer program 425 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 410 to provide generic access controls in a COM based computer network system having multiple users and servers.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

1. A method comprising:
separating loans from a lending entity into a first pool and a second pool, wherein the first pool comprises loans to borrowers with a better credit rating than the credit rating of borrowers corresponding to the loans in the second pool;
forming a third pool of funds as a function of the second pool; and
using funds from the third pool upon default of loans in the first pool.

2. The method of claim 1 wherein the lending entity comprises a school, the borrowers comprise students, and the loans comprise gap loans.

3. The method of claim 2 wherein the gap student loans are provided by a school to the students, and further comprising purchasing the first pool of gap student loans.

4. The method of claim 2 wherein the funds in the third pool are provided in exchange for purchase of the second pool by a third party and purchase of government guaranteed student loans.

5. The method of claim 2 wherein at least on of the elements is performed by programmed computer system.

6. The method of claim 2 and further comprising purchasing the gap student loans in the first pool.

7. The method of claim 6 and further comprising:
determining that a gap student loan in the first pool is in default; and
if the funds from the third pool are depleted, moving a gap student loan from the second pool to the first pool.

8. The method of claim 2 wherein gap student loans selected for the first pool correspond to students having a FICO credit rating score greater than approximately 500.

9. The method of claim 2 and further comprising servicing gap student loans from both the first and second pools.

10. The method of claim 2 wherein the funds in the third pool comprise government guaranteed student loans.

11. A method comprising:
receiving a batch of gap student loan applications from a school;
identifying selected gap student loan applications for a first pool and a second pool, wherein the first pool comprises loan applications from students with a better credit rating than the credit rating of students corresponding to the loan applications in the second pool;
purchasing loans made from the first pool of gap student loan applications;
forming a third pool of funds in exchange for purchasing select student loans; and
using funds from the third pool upon default of gap student loans in the first pool.

12. The method of claim 11 wherein the select student loans comprise government guaranteed student loans and loans made from the second pool of loan applications.

13. The method of claim 11 wherein the funds in the third pool comprise government guaranteed student loans.

14. The method of claim 13 wherein approximately 1 to 2 percent of corresponding government guaranteed student loans are put in the third pool.

15. The method of claim 11 wherein the funds in the third pool comprise cash.

16. The method of claim 11 wherein at least on of the elements is performed by programmed computer system.

17. The method of claim 11 wherein gap student loans selected for the first pool correspond to students having a FICO credit rating score greater than approximately 500.

18. The method of claim 11 and further comprising servicing gap student loans from both the first and second pools.

19. A system comprising:
means for receiving a batch of gap student loan applications from a school;
means for identifying selected gap student loan applications for a first pool and a second pool, wherein the first pool comprises loan applications from students with a better credit rating than the credit rating of students corresponding to the loan applications in the second pool;
means for purchasing loans made from the first pool of gap student loan applications;
means for forming a third pool of funds in exchange for purchasing select student loans; and
means for using funds from the third pool upon default of gap student loans in the first pool.

20. The method of claim 19 wherein the select student loans comprise government guaranteed student loans and loans made from the second pool of loan applications.

21. The method of claim 19 wherein the funds in the third pool comprise government guaranteed student loans.

22. The method of claim 21 wherein approximately 1 to 2 percent of corresponding government guaranteed student loans are put in the third pool.

23. A method comprising:
separating gap student loans into a first pool and a second pool, wherein the first pool comprises loans to students with a better credit rating than the credit rating of students corresponding to the gap student loans in the second pool; and
receiving funds from a third pool, formed by a third party in exchange for purchasing corresponding guaranteed loans, upon default of gap student loans in the first pool.
